(19) United States
(12) Patent Application Publication
(10) Pub. No.: US 2011/0144895 A1
(43) Pub. Date: Jun. 16, 2011

(54) METHOD AND DEVICE FOR ADJUSTING AN ENGINE COMBUSTION PARAMETER, RECORDING MEDIUM FOR THIS METHOD AND VEHICLE EQUIPPED WITH THIS DEVICE

(75) Inventors: Jean-Marc Gehin, Romagny sous Rougemont (FR); Phillippe Joly, Gambais (FR)

(73) Assignee: PEUGEOT CITROEN AUTOMOBILES SA, Velizy Villacoublay (FR)

(21) Appl. No.: 13/059,393

(22) PCT Filed: Jul. 23, 2009
(86) PCT No.: PCT/FR2009/051482

§ 371 Date: Feb. 16, 2011

(30) Foreign Application Priority Data
Aug. 26, 2008 (FR) 0855717

(51) Int. Cl. F02D 41/06; F02D 41/14

(52) U.S. Cl. 701/113; 123/435

(57) ABSTRACT

The invention relates to a method for adjusting a combustion parameter Pᵢ of a combustion engine during a cold start, characterized in that the value of the parameter Pᵢ is established (104) by interpolating between two predetermined values P_{iREF1} and P_{iREF2} as a function of the value ω of engine speed and of a temperature of an engine coolant, the values P_{iREF1} and P_{iREF2} being optimal in order to reduce pollutant emissions when the engine is running on reference fuel of respectively high volatility and low volatility.

The present invention claims the priority of French application 0855717 filed on Aug. 26, 2008, the content of which (text, drawings and claims) is incorporated here by reference.

The invention relates to a method and a device for adjusting at least one combustion parameter of an internal combustion engine during a cold start. The invention relates also to a recording medium for implementation of this method and a vehicle equipped with this device.

The combustion parameters of an engine are defined here as being adjustable parameters allowing a modification of the quantity of fuel or oxidizer injected in an engine cylinder, or a modification of the gas intake or gas exhaust timing of this cylinder, or a modification of the ignition timing of the gaseous mixture present in the cylinder.

By “cold start” is also understood, an engine start after a sufficiently long stop for the temperature of the engine to become equal to the coolant temperature of this engine. The temperature of the engine is here considered to be equal to the temperature of the internal skin of a cylinder of this engine.

The internal combustion engines considered here are engines susceptible of being supplied with low alcohol content fuels, in other words, fuels with zero or less than 10% alcohol content in volume, with low or high volatility and, fuels with high alcohol content, in other words fuels with alcohol content strictly greater than 10% and, by preference, greater than 50% in volume.

Typically, alcohol-free fuels contain only gasoline and a fuel with high alcohol content is a mixture of gasoline and vegetable alcohol, like the commercial fuel E85 which contains 85% ethanol and 15% gasoline.

Today, it is necessary to adjust the combustion parameters as a function of the characteristics of the consumed fuel, for instance, to reduce polluting emissions or to reduce noise. In particular, the combustion parameters must be adapted to the volatility of the consumed fuel. The volatility of the consumed fuel is measured, for instance, by its REID vapor pressure (RVP: Reid Vapor Pressure). As a reminder, the REID vapor pressure is the surface pressure of the fuel measured in an enclosure at 25° C. In this application, so-called high volatility fuels are fuels with REID vapor pressure greater than 800 millibar. Inversely, low volatility fuels, are fuels with REID vapor pressure lower than 500 millibar.

One of the problems encountered is that the closed loop control, intended to adjust these combustion parameters, functions correctly only from the time that the engine reaches a certain operating temperature. Therefore, during a cold start it is necessary to have a specific method for adjusting the combustion parameters as a function of the volatility of the fuel and the alcohol content. To be useful, this method must be fast, in other words it must be able to adjust the combustion parameters after one or a few cold starts.

In general, after a cold start, the engine reaches an operating temperature which allows an estimation of the volatility of the actually consumed fuel starting from other means than just the difference between the measured and predicted values of engine speed, expressed, for instance, in number of revolutions per minute of the crankshaft of the engine.

An example of a method for adjusting a combustion parameter of an engine is divulged in U.S. Pat. No. 6,079,396.

It was observed that engines employing this kind of methods are heavy polluters during the cold start phase and produce black exhaust smoke at very low temperature if the consumed fuel is highly volatile.

The goal of the invention is to remedy this drawback by proposing a method for adjusting a combustion parameter of an engine of an automotive vehicle during a cold start, in order to limit polluting emissions.

The goal of the invention is therefore a method for adjusting a combustion parameter Pᵢ in which the value of the parameter Pᵢ is established by interpolating between two predetermined values P_{iREF1} and P_{iREF2} as a function of the engine speed value ω and the coolant temperature of the engine, the values P_{iREF1} and P_{iREF2} are optimal for reducing polluting emissions when the engine is supplied with reference fuels, respectively, with high and low volatility.

The above mentioned method converges more rapidly towards an optimal value of parameter Pᵢ which reduces polluting emissions. This method limits the quantity of consumed fuel to the strict necessary and polluting emissions are therefore low during cold start.

In a variant, the value of the parameter Pᵢ is established by means of the following relationship Pᵢ=a×P_{iREF2}+(1−a)×P_{iREF1} where a is a coefficient between zero and one and its value is a function of an index i of the engine speed rise quality, index i is representative of the difference between the measured engine speed value ω and a predicted value ω_{iREFj} which should have been reached if the consumed fuel was one of the reference fuels with known volatility and if the value of the parameter Pᵢ was equal to the optimal value P_{iREF1} or P_{iREF2} of this reference fuel. Advantageously, the value of the coefficient a is a function of integrating index i over a predetermined period. In addition, the relationship between the value of coefficient a and the integral of index i is non-linear which allows us to increase the quality of the adjustment of parameter Pᵢ during a cold start.

In a variant, prior to establishing the value of parameter Pᵢ by interpolation, the value of this parameter is initialized at the value P_{iREF1} if the volatility of the consumed fuel is unknown, which advantageously limits polluting emissions.

The invention also relates to a medium for recording data comprising instructions for carrying out the above described adjustment method for at least one combustion parameter of the engine when these instructions are processed by an electronic processor.

The invention also relates to an adjustment device for at least one combustion parameter Pᵢ of an internal combustion engine during a cold start, in which the device comprises an electronic processor suitable for commanding at least one actuator for adjustment of the combustion parameter, this electronic processor is suitable for establishing the value of the parameter Pi by interpolation between two predetermined values P_{iREF1} and P_{iREF2} as a function of the engine speed value ω and the temperature of the engine coolant, the values P_{iREF1} and P_{iREF2} are optimal for reducing the polluting emissions when the engine is supplied with reference fuels, respectively, with high and low volatility.

The goal of the invention is also to provide a vehicle comprising the above device for adjusting at least one combustion parameter of the engine.

The invention will be better understood by reading the following description, given strictly as non-limiting example and with reference to the drawings in which:

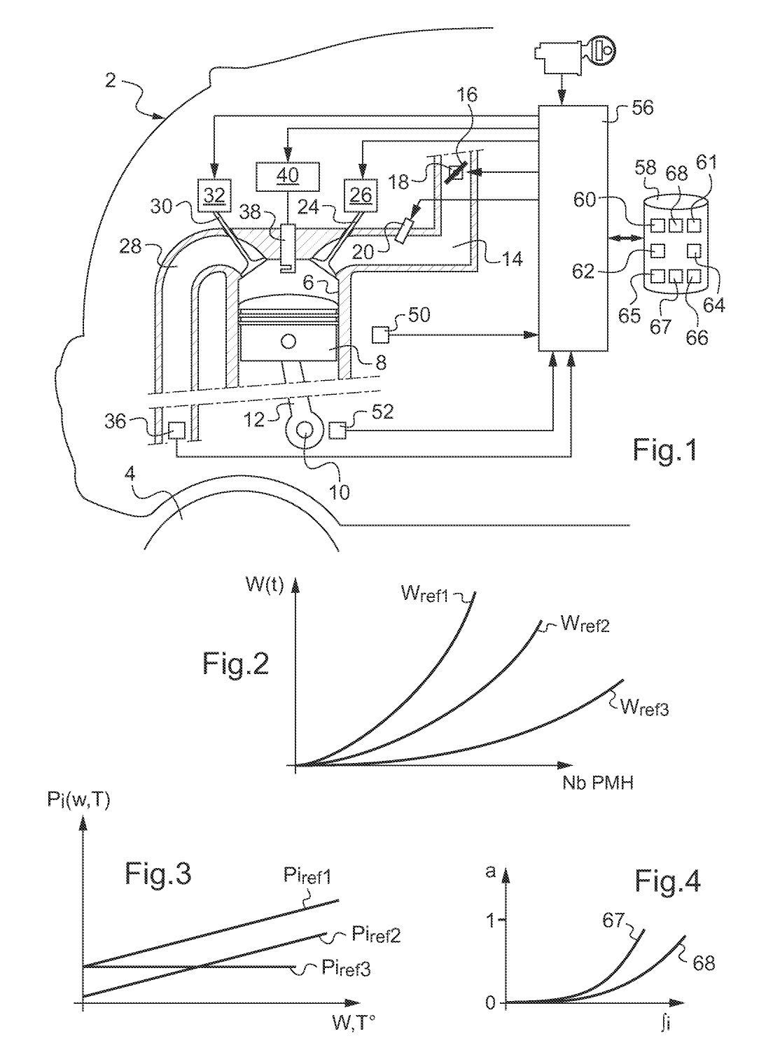

FIG. 1 is a schematic illustration of an automotive vehicle equipped with a device for adjusting the combustion parameters of an engine during a cold start,

FIGS. 2 to 4 are schematic illustrations of curves stored in a memory of the device of FIG. 1, and

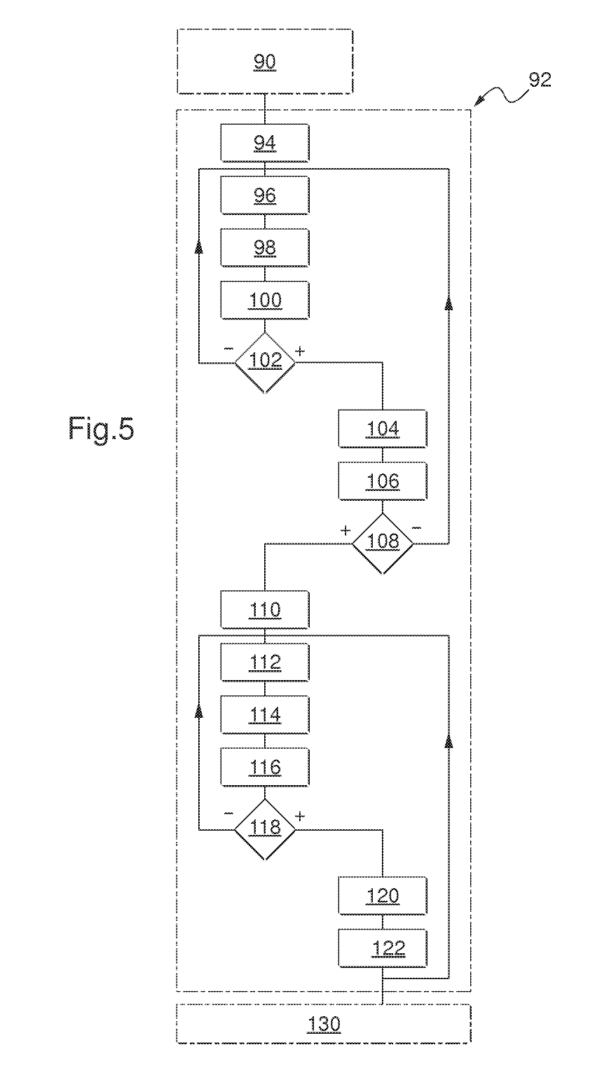

FIG. 5 is a flow chart of a method for adjusting engine combustion parameters of the vehicle of FIG. 1.

FIG. 1 shows an automotive vehicle 2, such as a car, equipped with an internal combustion engine suitable to provide traction to the wheels 4 of this vehicle. Only a part of this internal combustion engine is shown of FIG. 1. More precisely, the shown portion comprises a cylinder 6 in which a piston 8 is mounted in translation. Piston 8 drives crankshaft 10 through the intermediary of connecting rod 12. Crankshaft 10 drives the traction wheels 4 of the vehicle. The internal combustion engine also comprises a channel 14 for admission of the oxidizer, in other words the air, into cylinder 6. This channel 14 comprises a butterfly valve 16 which regulates through its angular position the quantity of air admitted in cylinder 6. The angular position of the butterfly valve is regulated by means of a commanded actuator 18.

The engine comprises also a fuel injector 20. As an illustration, here, injector 20 injects fuel directly into channel 14 to form a gaseous mixture with air. However, what is described here applies also in case injector 20 injects the fuel directly in the cylinder so that the gaseous mixture is formed only inside the cylinder.

The extremity of channel 14 which leads to the interior of cylinder 6 is closed by a valve 24 which moves in translation between an open position, in which the gaseous mixture consisting of fuel and air can be admitted inside cylinder 6 and, a closed position in which it is not possible to admit this gaseous mixture inside cylinder 6. The displacement of valve 24 between these two positions is controlled by a valve actuator 26. The valve actuator 26 can be a mechanical actuator such as a camshaft or an electromagnetic actuator.

The internal combustion engine also comprises for each cylinder an exhaust channel 28 through which the combustion residues are exhausted. The extremity of this channel 28, which leads to the interior of cylinder 6, can be closed by a valve 30 that moves between an open position and a closed position under the action of valve actuator 32. Same as actuator 26, actuator 32 can be a mechanical or an electromagnetic actuator. The exhaust channel 28 can, for instance, comprise a sensor 36 starting from which the air to fuel ratio of the gaseous mixture present in the cylinder is determined when the engine has reached it operating temperature.

The engine is also equipped with a spark plug 38 suitable to ignite the gaseous mixture present in cylinder 6. The ignition timing of spark plug 38 is commanded by ignition block 40.

Actuators 18, 26, 32, injector 20 and ignition block 40 are part of the device for adjusting the combustion parameters of the engine.

This device comprises also a sensor 50 for the temperature T of the engine coolant and a sensor 52 for the instantaneous value of the engine speed ω.

Finally, this device comprises an electronic processor 56 connected to a memory 58. Memory 58 comprises the different data, instructions and curves necessary for executing the method of FIG. 4.

More precisely, memory 58 comprises:
three curves 60 to 62 of the engine speed as a function of the number of upper dead points (UDP) counted since the start of the engine.
three curves 64 to 66 of the optimal values for adjusting the combustion parameters as a function of the measured engine speed value ω and coolant temperature T, and
two curves 67 and 68 from which the value of a coefficient a is obtained as a function of the integral of index i of the speed rise quality.

Here, the combustion parameters susceptible of being adjusted by the processor 56 are the following:
P₁(ω,T) which represents the quantity of fuel to be injected in cylinder 6,
P₂(ω,T) which represents the ignition time of the gaseous mixture present in cylinder 6,
P₃(ω,T) which represents the injection time of the fuel in cylinder 6,
P₄(ω,T) which corresponds with the quantity of air injected in cylinder 6, and
P₅(ω,T) which corresponds with the stroke length of valves 24 and 30.

As an example, here, the parameters P₁ to P₅ are adjusted, respectively, by means of the following actuators:
injector 20,
ignition block 40,
actuator 26,
actuator 18 and,
actuators 26 and 32.

FIG. 2 shows curves 60 to 62 in graphic form. Curves 60 to 62 were established, respectively, for the following three reference fuels:
a first reference fuel with low alcohol content and high volatility,
a second reference fuel with low alcohol content and low volatility, and
a third reference fuel with high alcohol content.

For instance, the third fuel is the E85 fuel. Here, the REID vapor pressure of the first reference fuel is equal to or greater than 900 millibar (90,000 Pa) while the REID vapor pressure of the second reference fuel is equal to or smaller than 450 millibar (45,000 Pa).

More precisely, curves 60 and 62 give the predicted value of the engine speed achieved at each upper dead point (UDP) if the consumed fuel is, respectively, the first, the second and the third reference fuel and the combustion parameters are optimal for the consumed fuel. The assumption is made here that the combustion parameters are optimal when they are adapted to the consumed fuel in order to reduce the polluting emissions of the vehicle. In the rest of the description, it is assumed that the combustion parameter values are optimal for a fuel with low alcohol content and high volatility, if an engine speed is obtained equal to +/−2% of the predicted speed of curve 60. In similar manner, it is assumed that the values of the combustion parameters are optimal in the case of a fuel with low alcohol content and low volatility and a fuel with high alcohol content, if an engine speed is obtained equal to +/−2% of the predicted speed starting, respectively, from curves 61 and 62.

More precisely, the x axis represents the number of upper dead points counted since the start of the engine and the y axis represents the value ω_{REFi} of the engine speed predicted by these curves. The curves ω_{REF1}, ω_{REF2} and ω_{REF3} represent the predicted engine speed values, respectively, through curves 60, 61, and 62.

FIG. 3 represents in graphical form curves 64 to 66 in the general case of parameter P₁(ω,T) where parameter Pᵢ corresponds with one of the parameters P₁ to P₅.

More precisely, the x axis of FIG. 3 represents the engine speed value ω and the temperature T, and the y axis represents the optimal value Pᵢ(ω,T) for parameter Pᵢ at angular speed ω and at temperature T. The curve P_{iREF1} represents the optimal value of parameter Pi when the fuel consumed by the engine is the first reference fuel. In similar manner, the curves P_{iREF2} and P_{iREF3} correspond with optimal values of the combustion parameter Pᵢ when the consumed fuels are, respectively, the second and third reference fuels. The form of the curves illustrated on FIG. 3 is given only for illustration purposes.

Here, each curve 64 to 66 establishes the optimal value of each of the parameters P1 to P5. These curves are constructed experimentally.

FIG. 4 represents in graphical form curves 67 and 68. These curves supply the value of a coefficient a between 0 and 1 as a function of the integral of an index i of the engine speed rise quality. Coefficient a and index i are described below in more detail. The relationship between coefficient a and the integral of index i is non-linear.

The operation of the device for adjusting the combustion parameters of the engine of FIG. 1 will now be described with respect to the process of FIG. 5.

The adjustment method of FIG. 5 starts with a recording step 90 of curves 60 to 68.

Once the vehicle 2 is delivered to the user, at least after each refueling, the adjustment device goes through a cold start step 92. More precisely, step 92 starts when the start of the engine is detected and the engine temperature is equal to the coolant temperature.

At the very beginning of step 92, the adjustment values of the different combustion parameters are initialized, during step 94, by means of values established starting from curve 64. By default, the engine is adjusted to function in optimal manner with an alcohol-free highly volatile fuel.

Then, during step 96, the instantaneous engine speed value ω is measured by means of sensor 52. The number of upper dead points elapsed since the start of the engine and the coolant temperature are also measured during this step 96. Here, the coolant temperature is obtained starting from measurements made by sensor 50.

Then, during step 98, the predicted value ω_{REF1} is established by means of curve 60 and the number of upper dead points counted since the start of the engine.

During the next step 100, the processor 56 computes an index i of the engine speed rise quality. For instance, here, this index i is obtained by means of the following relationship i=ω_{REF1}−ω.

During step 102, the value of the index i is compared with a predetermined threshold S₁.

If index i is lower than threshold S₁, then the process returns to step 96. Indeed, this means that the actually used adjustment is optimal for the actually consumed fuel and therefore it is not necessary to change the adjustment. For instance, this corresponds with the case where the value ω is equal to or greater than the value ω_{REF1}.

In the opposite case, in other words if the used adjustment is not optimal for the actually consumed fuel, then the measured instantaneous value ω is smaller than the predicted value starting from curve 60. In this case, the processor 56 executes step 104 during which new values are calculated for the different combustion parameters Pᵢ. For instance, during step 104, the new values for adjustment of combustion parameters Pᵢ are obtained by means of the following relationship:

Pᵢ=a×P_{iREF2}+(1−a)×P_{iREF1} in which:
P_{iREF1} and P_{iREF2} are, respectively, the optimal values of parameter Pᵢ established starting from curves 64 and 65, of the measured value ω and the measured temperature T, and
a is a coefficient between 0 and 1.

Coefficient a is obtained starting from curve 67. To this end, an integration is performed of the different values of index i measured since the start of the engine until the present time. The result of this integration constitutes the integral of index i.

At the end of step 104, parameters P₁ to P₅ are adjusted. For instance, the new values of parameters P₁ to P₅ are applied to the engine by commanding the different actuators 18, 26 and 32, injector 20 and ignition block 40.

Following step 104, in a step 106 a counter N indicates the number of upper dead points (UDP) elapsed since the value of coefficient a became equal to 1. If the value of the coefficient is different than 1 then this counter N is reinitialized to the zero value.

During step 108, the value of this counter N is compared with a predetermined threshold S₂. If the value of the counter N is smaller than threshold S₂, then the process returns to step 96. The threshold S₂ is greater than 2 and a function of the measured temperature T.

In the opposite case, the process proceeds to step 110 during which the adjustment values of the different parameters Pi are calculated in different manner than in step 104. In fact, if after several upper dead points, an optimal value of the different adjustment parameters was not achieved by reiterating steps 96 to 108, this means that the actually used fuel contains high alcohol content.

During step 110, the adjustment value for the different parameters Pᵢ is for instance calculated by means of the following relationship: Pᵢ=P_{iREF3}, where Pᵢ is the value of the nth adjustment parameter, and P_{iREF3} is the value of the nth adjustment parameter obtained starting from curve 66, of the measured value ω and the measured temperature T.

At the end of step 110, the new adjustment values of parameters Pᵢ are applied to the engine of vehicle 2. In this way, at the end of step 110, the combustion parameters applied to the engine are those which are optimal for the reference fuel with high alcohol content.

Then, during step 112, the instantaneous value ω, the number of upper dead points counted since the start of the engine and the coolant temperature T are measured again.

During step 114, the value ω_{REF3}, which the engine speed must have if the consumed fuel is a fuel with high alcohol content, is established starting from curve 62 and the number of upper dead points counted.

During step 116, a new index i of the speed rise quality is calculated. During step 116, for instance, index i is calculated by means of the following relationship: i=ω−ω_{REF3}, where ω_{REF3} is the predicted value of the engine speed obtained starting from curve 62 and the number of upper dead points counted.

During step 118, the value of this index i is compared with a predetermined threshold S₃. If the value of index i is smaller than or equal to this predetermined threshold, the process returns to step 112. In fact, this means that the adjustment values for the actually used parameters Pi are optimal and therefore it is not necessary to modify them immediately. For instance, this corresponds with the case where the value ω is smaller than or equal to the value ω_{REF3}.

In the opposite case, new adjustment values of parameters Pᵢ are calculated during step 120. For instance, during this step 120, the adjustment values for parameters Pᵢ are calculated by means of the following relationship: Pᵢ=a×P_{iREF3}+(1−a)P_{iREF2}, where P_{iREF2} and P_{iREF3} are optimal values of parameter Pᵢ established starting from curves 65 and 66, of the instantaneous value ω and the coolant temperature T, and a is a weighting coefficient between 0 and 1 established by means of curve 68.

For instance, the weighting coefficient a is calculated by means of curve 68 and the integral of index i calculated over a period starting from the execution of step 110.

Then, during step 122, these new adjustment values for parameters Pᵢ are applied to the engine through the intermediary of actuators 18, 26, 32, injector 20 and ignition block 40.

At the end of step 122, the process returns to step 112.

Step 92 ends as soon as the start of the engine is terminated, in other words when, after having brusquely increased, the value ω of the engine speed decreases to reach a value corresponding with the idle speed of the engine. The duration of the start phase can also be fixed to a constant predetermined value.

The values for adjusting the parameters Pᵢ can be stored and used again during the next cold start if no refilling of the fuel tank was detected between these two cold starts.

After step 92, a step 130 takes place in which the values of the different parameters Pᵢ are adjusted. However, contrary to what takes place in step 92, in step 130, the values of the different parameters Pᵢ are not adjusted only as a function of the difference between the instantaneous value ω and a predicted engine speed value. For instance, in step 130, the different values of the parameters Pi are adjusted starting from the air to fuel ratio obtained starting from data sensor 36.

Numerous other implementation modes are possible. For instance, instead of measuring the temperature or the engine speed, the corresponding values can be estimated starting from an engine model.

During step 104, the value of coefficient a can be calculated by means of the following relationship: a=(ω−ω_{REF1})/(ω_{REF2} ω_{REF1}) where: ω is the measured instantaneous engine speed value, and ω_{REF1} and ω_{REF2} are respectively the engine speed values established starting from curves 60 and 61 and the number of upper dead points counted since the start of the engine.

In similar manner, during step 120, the value of coefficient a can be calculated by means of the following relationship: a=(ω−ω_{REF2})/(ω_{REF3}−ω_{REF2}) where: ω is the measured instantaneous engine speed value, and ω_{REF2} and ω_{REF3} are engine speed values established by means of curves 61 and 62 and the number of upper dead points counted since the start of the engine.

1. A method for adjusting a combustion parameter Pᵢ of an internal combustion engine during a cold start, the method comprising establishing the value of the parameter Pᵢ by interpolation between two predetermined values P_{iREF1} and P_{iREF2} as a function of the engine speed value ω and the engine coolant temperature, the values P_{iREF1} and P_{iREF2} being optimal for reducing polluting emissions when the engine is supplied with high volatility and low volatility reference fuels.

2. The method according to claim 1, in which the value of parameter Pi is established by means of the following relationship:
P₁=a×P_{iREF2}+(1−a)×P_{iREF1}
where a is a coefficient between zero and one and its value is a function of an index i of speed rise quality, the index i being representative of the difference between the measured engine speed value ω and a predicted value ω_{REFj} which would be achieved if the consumed fuel was one of the reference fuels with known volatility and the value of the parameter Pᵢ was equal to the optimal value P_{iREF1} or P_{iREF2} of this reference fuel.

3. The method according to claim 2, in which the value of the coefficient a is a function of the integration of index i over a predetermined period.

4. The method according to claim 3, in which the relationship between the value of coefficient a and the integral of index i is non-linear.

5. The method according to claim 1, in which prior to establishing the value of parameter Pᵢ by interpolation, the value of parameter Pᵢ is initialized at the value P_{iREF1} if the volatility of the consumed fuel is unknown.

6. A non-transitory medium for recording data, characterized in that the medium comprises instructions for executing a method for adjusting at least one combustion parameter according to claim 1, when these instructions are executed by an electronic processor.

7. A device for adjusting at least one combustion parameter Pᵢ of an internal combustion engine during a cold start; the device comprising an electronic processor suitable for commanding at least one actuator for adjusting a combustion parameter Pᵢ, the electronic processor being suitable for establishing the value of parameter Pᵢ by interpolation between two predetermined values P_{iREF1} and P_{iREF2} as a function of the engine speed value ω and the engine coolant temperature, the values P_{iREF1} and P_{iREF2} being optimal for reducing polluting emissions when the engine is supplied with high volatility and low volatility reference fuels.

8. The device according to claim 7 wherein the device is installed in a vehicle.
